(19) United States
(12) Patent Application Publication
(10) Pub. No.: US 2017/0343696 A1
(43) Pub. Date: Nov. 30, 2017

(54) SHOULDER EFFECT REDUCTION

(71) Applicant: HALLIBURTON ENERGY SERVICES, INC., Houston, TX (US)

(72) Inventor: Yumei Tang, Tomball, TX (US)

(73) Assignee: HALLIBURTON ENERGY SERVICES, INC., Houston, TX (US)

(21) Appl. No.: 15/527,292

(22) PCT Filed: Dec. 18, 2014
(86) PCT No.: PCT/US2014/071101

§ 371 Date: May 16, 2017

(51) Int. Cl. G01V 3/28; G01V 3/38

(52) U.S. Cl. CPC G01V 3/28; G01V 3/38

(57) ABSTRACT

Methods and systems for reducing shoulder effect are disclosed. Some method embodiments include obtaining resistivity logging data corresponding to a resistivity logging tool's position in a formation position; performing an anisotropic single-layer inversion on the resistivity logging data to determine a horizontal resistivity, a vertical resistivity, and a dip angle of the formation at the tool's position; detecting a location of a boundary of the formation and performing a vertical multi-layer inversion based on the resistivity logging data in a window around said location, if a residual error for the anisotropic inversion exceeds a threshold; and displaying a log of at least one inversion parameter from the anisotropic inversion or the vertical inversion based on said residual error.

### BACKGROUND

The gathering of downhole information has been performed by the oil industry for many years. Modern petroleum drilling and production operations demand a great quantity of information relating to the parameters and conditions downhole. Such information typically includes the location and orientation of the borehole and drilling assembly, earth formation properties, and drilling environment parameters downhole. The gathering of information relating to formation properties and conditions downhole is commonly referred to as “logging”, and can be performed during the drilling process itself.

Various measurement tools exist for use in logging while drilling. One such tool is the electromagnetic resistivity tool, which includes one or more antennas for transmitting an electromagnetic signal into the formation and one or more antennas for receiving a formation response. When operated at low frequencies, the electromagnetic resistivity tool (resistivity tool) may be called an “induction” tool, and at high frequencies it may be called an electromagnetic wave propagation tool. Though the physical phenomena that dominate the measurement may vary with frequency, the operating principles for the tool are consistent. In some cases, the amplitude and/or the phase of the received signals are compared to the amplitude and/or phase of the transmitted signals to measure the formation resistivity. In other cases, the amplitude and/or phase of the different received signals are compared to each other to measure the formation resistivity.

When plotted as a function of time or position, the resistivity tool measurements are termed “logs” or “resistivity logs”. Such logs may provide indications of hydrocarbon concentrations and other information useful to drillers and completion engineers. In particular, logs may provide information useful for steering the drilling assembly. Electromagnetic resistivity tools have been widely used to explore the subsurface based on the electrical resistivity (or its inverse, conductivity) of the rock formation. The formation with a higher resistivity indicates a higher possibility of hydrocarbon accumulations.

Artifacts can occur in resistivity logs. Specifically, the resistivity of one layer of an earth formation may interfere with the logging of resistivities of surrounding layers, especially at layer boundaries of anisotropic formations, leading to errors. The change in resistivity between the layers can cause charge accumulation on the boundary between layers, further distorting measurements at the boundary location. This is sometimes called the “shoulder” or “shoulder-bed” effect. Such artifacts decrease logging accuracy, which decreases efficiency.

### BRIEF DESCRIPTION OF THE DRAWINGS

For a detailed description of the various disclosed embodiments, reference will now be made to the accompanying drawings in which:

FIG. 1 is an illustration of a logging while drilling environment implementing shoulder effect reduction;

FIG. 2 is an illustration of a resistivity logging tool compatible with shoulder effect reduction;

FIG. 3 is a plot for describing antenna orientation of the logging tool;

FIG. 4 is a flow chart showing a shoulder effect reduction method;

FIG. 5 is a diagram showing a system for shoulder effect reduction;

FIG. 6 is a plot showing the shoulder effect; and

FIG. 7 is an illustration of a wireline logging environment implementing shoulder effect reduction.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical connection. Thus, if a first device couples to a second device, that connection may be through a direct electrical connection, or through an indirect electrical connection via other devices and connections. In addition, the term “attached” is intended to mean either an indirect or a direct physical connection. Thus, if a first device attaches to a second device, that connection may be through a direct physical connection, or through an indirect physical connection via other devices and connections.

### DETAILED DESCRIPTION

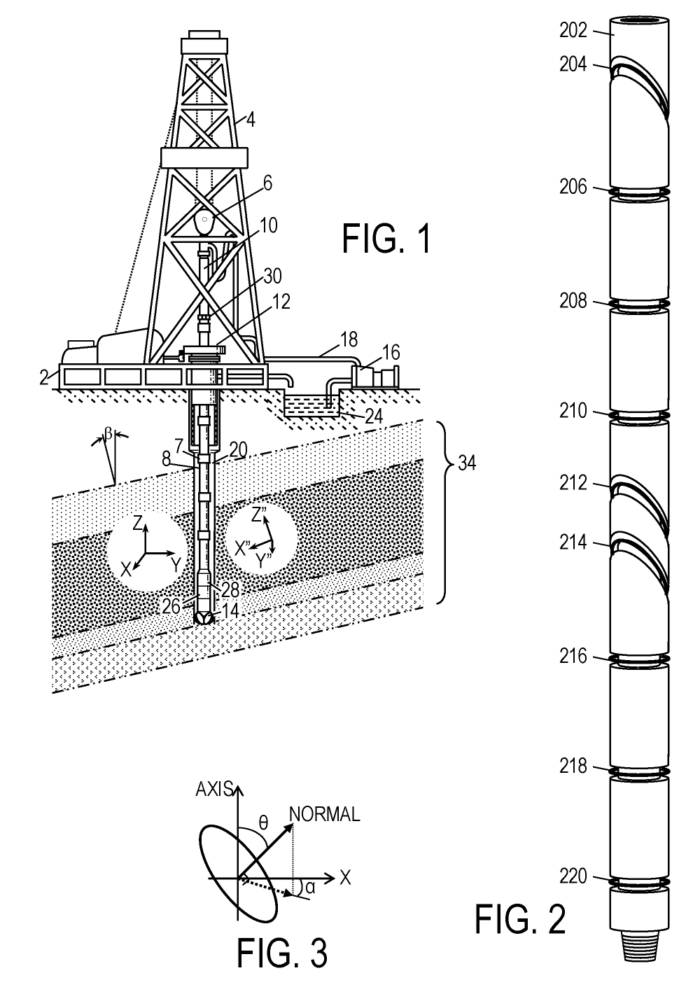

The issues identified in the background are at least partly addressed by systems and methods for reducing the shoulder effect both in a wireline environment and in a logging while drilling (LWD) environment. To illustrate a context for the disclosed systems and methods, FIG. 1 shows a well during drilling operations. A drilling platform 2 is equipped with a derrick 4 that supports a hoist 6. Drilling of oil and gas wells is carried out by a string of drill pipes connected together by “tool” joints 7 so as to form a drill string 8. The hoist 6 suspends a kelly 10 that lowers the drill string 8 through rotary table 12. Connected to the lower end of the drill string 8 is a drill bit 14. The bit 14 is rotated and drilling accomplished by rotating the drill string 8, by use of a downhole motor near the drill bit, or by both methods.

Drilling fluid, termed mud, is pumped by mud recirculation equipment 16 through supply pipe 18, through drilling kelly 10, and down through the drill string 8 at high pressures and volumes to emerge through nozzles or jets in the drill bit 14. The mud then travels back up the hole via the annulus formed between the exterior of the drill string 8 and the borehole wall 20, through a blowout preventer, and into a mud pit 24 on the surface. On the surface, the drilling mud is cleaned and then recirculated by recirculation equipment 16.

For a LWD environment, downhole sensors 26 are located in the drillstring 8 near the drill bit 14. Sensors 26 may include directional instrumentation and a modular resistivity tool with tilted antennas. The directional instrumentation measures the inclination angle, the horizontal angle, and the azimuthal angle (also known as the rotational or “tool face” angle) of the LWD tools. As is commonly defined in the art, the inclination angle is the deviation from vertically downward, the horizontal angle is the angle in a horizontal plane from true North, and the tool face angle is the orientation (rotational about the tool axis) angle from the high side of the well bore. In some embodiments, directional measurements are made as follows: a three axis accelerometer measures the earth's gravitational field vector relative to the tool axis and a point on the circumference of the tool called the “tool face scribe line”. (The tool face scribe line is drawn on the tool surface as a line parallel to the tool axis.) From this measurement, the inclination and tool face angle of the LWD tool can be determined. Additionally, a three axis magnetometer measures the earth's magnetic field vector in a similar manner. From the combined magnetometer and accelerometer data, the horizontal angle of the LWD tool can be determined. In addition, a gyroscope or other form of inertial sensor may be incorporated to perform position measurements and further refine the orientation measurements.

In some embodiments, downhole sensors 26 are coupled to a telemetry transmitter 28 that transmits telemetry signals by modulating the mud flow in drill string 8. A telemetry receiver 30 is coupled to the kelly 10 to receive transmitted telemetry signals. Other telemetry transmission techniques may also be used. The receiver 30 communicates the telemetry to a surface installation (not shown) that processes and stores the measurements. The surface installation typically includes a computer system that may be used to inform the driller of the relative position and distance between the drill bit and nearby bed boundaries.

The drill bit 14 is shown penetrating a formation having a series of layered beds 34 dipping at an angle. A first (x, y, z) coordinate system associated with the sensors 26 is shown, and a second coordinate system (x″, y″, z″) associated with the beds 32 is shown. The bed coordinate system has the z″ axis perpendicular to the bedding plane, has the y″ axis in a horizontal plane, and has the x″ axis pointing “downhill”. The angle between the z-axes of the two coordinate systems is referred to as the “dip” or “dip angle” and is shown in FIG. 1 as the angle β.

For a wireline environment, as shown in FIG. 7, a drilling platform 102 is equipped with a derrick 104 that supports a hoist 106. At various times during the drilling process, the drill string is removed from the borehole. Once the drill string has been removed, logging operations can be conducted using a wireline logging tool 134, i.e., a sensing instrument sonde suspended by a cable 142, run through the rotary table 112, having conductors for transporting power to the tool and telemetry from the tool to the surface. A multi-component induction logging portion of the logging tool 134 may have centralizing arms 136 that center the tool within the borehole as the tool is pulled uphole. A logging facility 144 collects measurements from the logging tool 134, and includes a processing system for processing and storing the measurements 121 gathered by the logging tool from the formation.

Referring now to FIG. 2, an illustrative resistivity tool 202 is shown. The tool 202 is provided with one or more regions of reduced diameter for suspending a wire coil. The wire coil is placed in the region and spaced away from the tool surface by a constant distance. To mechanically support and protect the coil, a non-conductive filler material (not shown) such as epoxy, rubber, fiberglass, or ceramics may be used to fill in the reduced diameter regions. The transmitter and receiver coils may comprise as little as one loop of wire, although more loops may provide additional signal power. The distance between the coils and the tool surface is preferably in the range from 1/16 inch to ¾ inch, but may be larger.

The illustrated resistivity tool 202 has six coaxial transmitters 206 (T5), 208 (T3), 210 (T1), 216 (T2), 218 (T4), and 220 (T6), meaning that the axes of these transmitters coincide with the longitudinal axis of the tool. In addition, tool 202 has three tilted receiver antennas 204 (R3), 212 (R1), and 214 (R2). The term “tilted” indicates that the plane of the coil is not perpendicular to the longitudinal tool axis. (FIG. 3 shows an antenna that lies within a plane having a normal vector at an angle of θ with the tool axis and at an azimuth of a with respect to the tool face scribe line. When θ equals zero, the antenna is said to be coaxial, and when θ is greater than zero the antenna is said to be tilted.) The spacing of the antennas may be stated in terms of a length parameter x, which in some embodiments is about 16 inches. Measuring along the longitudinal axis from a midpoint between the centers of receiver antennas 212 and 214, transmitters 210 and 216 are located at ±1x, transmitters 208 and 218 are located at ±2x, and transmitters 206 and 220 are located at ±3x. The receiver antennas 212 and 214 may be located at ±x/4. In addition, a receiver antenna 204 may be located at plus or minus 4x.

The length parameter and spacing coefficients may be varied as desired to provide greater or lesser depth of investigation, higher spatial resolution, or higher signal to noise ratio. However, with the illustrated spacing, symmetric resistivity measurements can be made with 1x, 2x, and 3x spacing between the tilted receiver antenna pair 212, 214, and the respective transmitter pairs 210 (T1), 216 (T2); 208 (T3), 218 (T4); and 206 (T5), 220 (T6). In addition, asymmetric resistivity measurements can be made with 1x, 2x, 3x, 5x, 6x, and 7x spacing between the tilted receiver antenna 204 and the respective transmitter 206, 208, 210, 216, 218, and 220. This spacing configuration provides tool 202 with some versatility, enabling it to perform deep (but asymmetric) measurements for bed boundary detection and symmetric measurements for accurate azimuthal resistivity determination.

In some contemplated embodiments, the transmitters may be tilted and the receivers may be coaxial, while in other embodiments, both the transmitters and receivers are tilted, though preferably the transmitter and receiver tilt angles are different for at least some of the transmitter-receiver antenna pairs. Moreover, the roles of transmitter and receiver may be interchanged while preserving the usefulness of the measurements made by the tool. In operation, each of the transmitters is energized in turn, and the phase and amplitude of the resulting voltage induced in each of the receiver coils are measured. From these measurements, or a combination of these measurements, the formation resistivity can be determined.

In the illustrated embodiment of FIG. 2, the receiver coils are tilted with a 45° angle between the normal and the tool axis. Angles other than 45° may be employed, and in some contemplated embodiments, the receiver coils are tilted at unequal angles or are tilted in different azimuthal directions. The tool 202 is rotated during the drilling (and logging) process, so that resistivity measurements can be made with the tilted coils oriented in different azimuthal directions. The 360 degrees of the azimuthal plane may be divided into M number of equal sections or bins, each bin covering 360/M degrees. For example, there may be 32 bins covering 11.25 degrees each, and the tool 202 may log amplitude and phase measurements with different transmitter/receiver spacing and frequency for each bin.

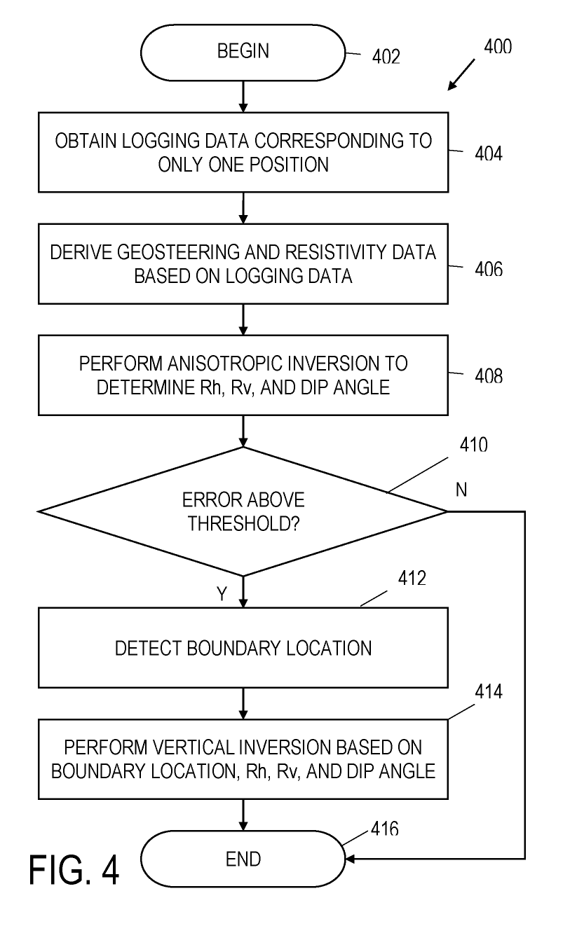

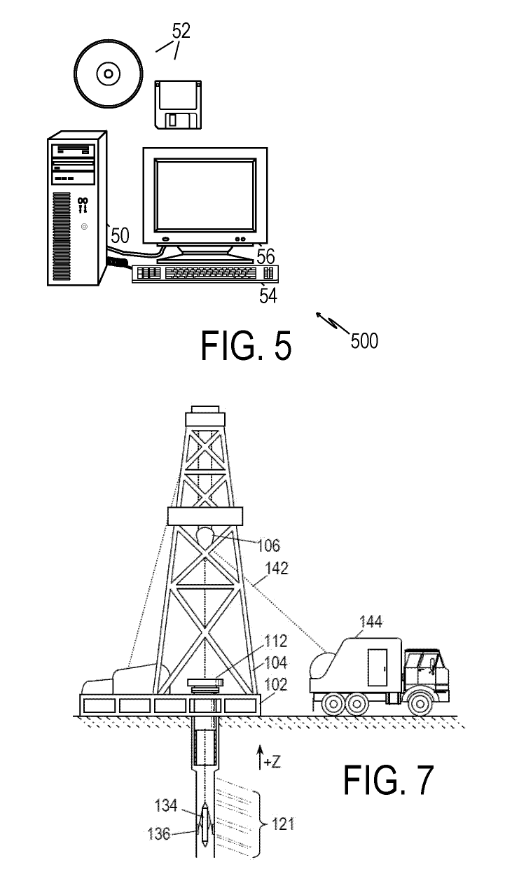

FIG. 4 is a flow chart of an illustrative method 400 of reducing the shoulder effect beginning at 402 and ending at 416. This method 400 may be performed by one or more processors in the tool alone or in cooperation with a surface computing facility. The processors may execute any step described in this disclosure as a result of executing software as described below with regard to FIG. 5. At 404, the amplitude and phase measurements for each bin at only one tool 202 position may be obtained.

At 406, resistivity and geosteering data may be derived based on the received logging data from a given position. Resistivity data may include values representative of formation resistivity at different azimuths and radial distances. Geosteering data may include the difference between measurements from the opposite azimuthal orientations of the tool 202, or may instead be based on some other azimuthal dependence of the tool measurements at that position.

The derived resistivity and geosteering data may be based on the average of differences between measurements of two transmitter/receiver pairs in at least one embodiment. For example, the phase and amplitude data received by receivers R1 and R2 based on excitation of transmitter T1 (the first transmitter/receiver pair being T1R1, and the second transmitter/receiver pair being T1R2) may be used in conjunction with Equations (1)-(4) below to derive compensated resistivity and geosteering data. The resistivity data may be derived by

ΔA_{T1}(k)=20 log(A_{R1T1}(k))−20 log(A_{R2T1}(k)) (1)

Δφ_{T1}(k)=φ_{R1T1}(k)−φ_{R2T1}(k) (2)

where A is amplitude, φ is phase, R is a receiver, T is a transmitter, and k is the bin number. For example, A_{R1T1}(k) is the amplitude of measurement on receiver R1 excited by source T1 at bin k. The average resistivity may be derived from the average difference of amplitude and phase of the measurements from different transmitter/receiver pairs, different frequencies, and/or different bins.

The geosteering data may be derived by taking the difference between phase or log amplitude for a specific bin and the average phase or log amplitude for all bins. The geosteering data may be derived by:

$$\begin{matrix}{amp}_{R 1 T 1} ( k ) = 20 log ( {A}_{R 1 T 1} ( k ) ) - \frac{1}{32} {\sum }_{i = 1 , 32}^{ } 20 log ( {A}_{R 1 T 1} ( i ) ) & ( 3 ) \\ {pha}_{R 1 T 1} ( k ) = {φ}_{R 1 T 1} ( k ) - \frac{1}{32} {\sum }_{i = 1 , 32}^{ } {φ}_{R 1 T 1} ( i ) & ( 4 )\end{matrix}$$

where amp is amplitude (derived), pha is phase (derived), A is amplitude, φ is phase, R is a receiver, and T is a transmitter.

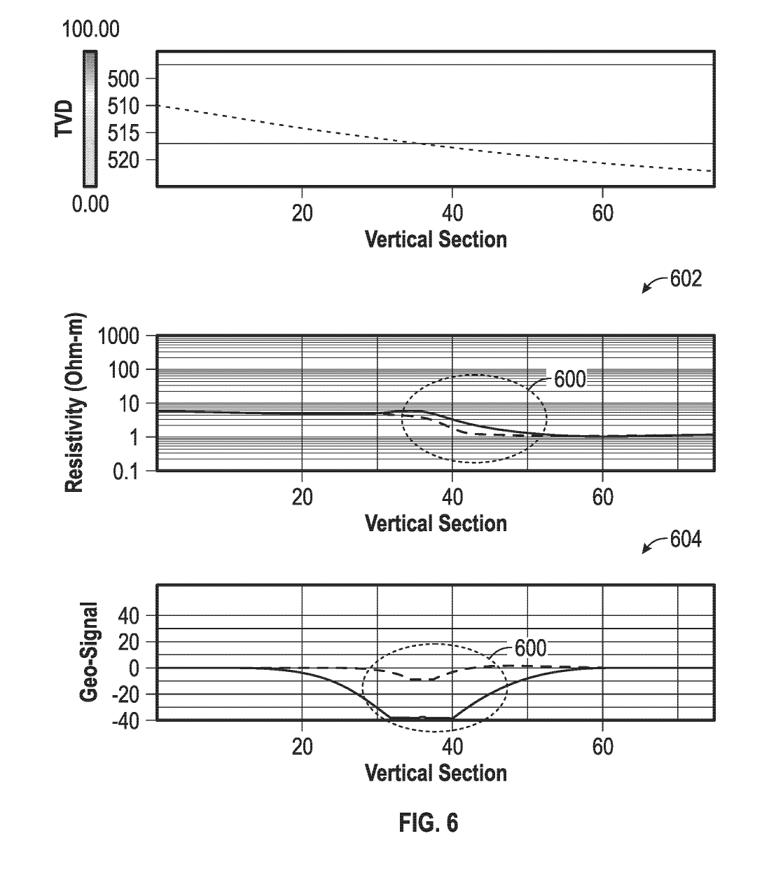

For the same formation, different values for resistivity or geosteering may be derived for the same location in the formation from transmitter/receiver pairs having different antenna spacing and/or different relative orientations. This separation may be due to the anisotropy of the formation or it may be due to the shoulder effect. FIG. 6 illustrates such a separation 600 in both the resistivity data 602 and the geosteering data 604.

In order to determine if the shoulder effect is present, at 408, an anisotropic inversion is performed on the resistivity and geosteering data to determine a horizontal resistivity (Rh), a vertical resistivity (Rv), and dip angle (β) of the formation. Horizontal resistivity is the formation resistivity in the direction parallel to the layers of the formation. Vertical resistivity is the formation resistivity in the direction perpendicular to the layers of the formation. In at least one embodiment, average resistivities from different transmitter/receiver pairs, frequencies, and bins are used in the inversion.

First, a cost function equation is defined based on the difference between a simulation result from modeling the resistivity data and measurements from the tool 202. In at least one embodiment, the cost function is defined as C=∥(\vec{S}−\vec{M})∥, where the ∥ ∥ operator is the L₂ norm of the difference (misfit) vector, \vec{S} is the simulation result (i.e., the vector of predicted tool measurements) from modeling the resistivity data, and \vec{M} is the vector of actual measurements from the tool 202. For the anisotropic inversion, the model assumes that the formation includes only one homogenous layer in at least one embodiment. Next, the cost function is minimized for the parameters Rh, Rv, and dip angle, and the model is updated. More iterations of minimizing the cost function are performed until the parameters converge. The iteration can be implemented using a least squares method, the Marquardt-Levenberg method, the Gauss-Newton method, and the like.

At 410, if the total residual error associated with the anisotropic inversion is not above a reference threshold, e.g. a tolerance of 10⁻⁵ for terminating the inversion at each logging point, then the shoulder effect is not present, and the method may end at 416. However, if the total error associated with the anisotropic inversion is above the reference threshold, then the shoulder effect is determined to be present and should be corrected.

At 412, a boundary location of the formation corresponding to the separation of resistivities is detected. Specifically, relative errors in the model of resistivity data for various positions of a sliding window along the formation are calculated. For example, one three-foot window of data may be incrementally shifted 2 inches of distance at a time along the formation region having residual errors above the threshold. These relative errors may vary considerably, and the errors are compared. The location of the window(s) having the largest relative error (or local maxima) may be identified as the boundary location. Some embodiments permit the identification of multiple boundary locations in the regions having residual errors above the threshold.

At 414, a vertical inversion is performed based on the boundary location and results of the first anisotropic inversion (from block 408). First, a cost function equation is defined based on the difference between measurements from the tool 202 and a simulation result from modeling the resistivity data. However, unlike the anisotropic inversion, the vertical inversion model assumes that the formation includes 2, 3, 4, or more layers in various embodiments. For example, if 2 layers are assumed, then a window having a fixed vertical size is centered around a boundary location identified at 412. In at least one embodiment, the fixed vertical size may be 3 feet (extending 1.5 feet above the identified boundary, and extending 1.5 feet below the identified boundary). Generally, the greater the fixed vertical size, the more layers that are permitted to be in the formation. A 3 foot window size would correspond to 2 layers. ext, the cost function is minimized for the parameters Rh, Rv, dip angle, and boundary location and the model is updated. More iterations of minimizing the cost function are performed until the parameters converge. The iteration can be implemented using a least squares method, the Marquardt-Levenberg method, the Gauss-Newton method, and the like. The converged parameters Rh, Rv, dip angle, and boundary location are more accurate than the derived resistivity and geosteering data because the vertical inversion accounts for the shoulder effect, thereby reducing or eliminating the separation between the resistivity parameters derived from different transmitter-receiver antenna pairs. As such, logs based on the converged parameters are more accurate.

The resistivity measurement, resistivity logs, converged parameters, and/or result of the method 400 may be communicated to a user in at least one embodiment. For example, the measurement, logs, and/or results may be displayed, preferably while logging (and drilling) operations are ongoing, enabling the user to steer the drilling assembly with the benefit of this information. The display may be updated as each measurement is made, or alternatively, may be updated in stages, i.e., after a sufficient number of measurements have been acquired for a given tool position. FIG. 5 illustrates a shoulder-reduction system 500 capable of such display. The system 500 includes a data processing system 50, which includes mediums such as internal data storage and memory having software (represented by removable information storage mediums 52), along with one or more processor cores that execute the software and perform any of the steps described in this disclosure. The software configures the system to interact with a user via one or more input/output devices (such as keyboard 54 and display 56 through which any final or intermediate value, diagram, information, or alert described in this disclosure may be displayed).

The conservation of time and computational resources, in addition to the increase in logging accuracy, enabled by this disclosure allows for more productivity, better interpretation of the logs, and faster identification of hydrocarbon reserves. Specifically, the shoulder effect may be identified and corrected if present, and a geosteering trajectory may be derived based on data from the anisotropic or vertical inversion. The drillstring may be steered based on the derived geosteering trajectory. If not present, then logging may continue without correction. Additionally, such correction may be performed based on measurements from the tool 202 at only one position, or logging point, rather than multiple positions, or logging points. Specifically, as discussed above, multiple measurements of different spacing size and frequencies at one logging point, using multiple relative antenna orientations, may be used with long spacing sizes used for measurements farther in the formation and short spacing sizes used for measurements nearer in the formation. Similarly, low frequency data may be used for measurements farther in the formation, while high frequency data may be used for measurements nearer in the formation.

A resistivity logging method, includes: obtaining resistivity logging data corresponding to a resistivity logging tool's position in a formation position; performing an anisotropic single-layer inversion on the resistivity logging data to determine a horizontal resistivity, a vertical resistivity, and a dip angle of the formation at the tool's position; detecting a location of a boundary of the formation and performing a vertical multi-layer inversion based on the resistivity logging data in a window around said location, if a residual error for the anisotropic inversion exceeds a threshold; and displaying a log of at least one inversion parameter from the anisotropic inversion or the vertical inversion based on said residual error.

The method may include conveying the tool along a borehole through the formation. The method may include recording, on a non-transitory information storage medium, a log of the horizontal resistivity, vertical resistivity, or dip angle. Obtaining resistivity logging data may include obtaining resistivity logging data using multiple relative antenna orientations. The method may include deriving a geosteering trajectory based at least in part on the at least one inversion parameter. The drill string may be steered based on the derived trajectory. Detecting the location may include detecting the location of the boundary of the formation only if an error of the anisotropic inversion is above a threshold. Performing the vertical inversion may include performing the vertical inversion based on the location, horizontal resistivity, vertical resistivity, and dip angle only if an error of the anisotropic inversion is above a threshold. Deriving average resistivities may include: deriving an average resistivity for a transmitter and receiver pair; and deriving an average resistivity for another transmitter and receiver pair. Performing the vertical inversion may include minimizing a cost function until a parameter of the formation converges to a value. The parameter may be the location of the boundary. The cost function may include the difference between measurements from the logging data and a model of the formation. The method may include deriving geosteering data based on the logging data. Detecting the location may include detecting a location of a boundary of the formation based on the geosteering data. The logging tool may be a logging while drilling (LWD) tool.

A non-transitory computer-readable storage system includes instructions that, when executed, cause one or more processors to: obtain earth formation logging data corresponding to only one position of a logging tool; derive average resistivities for locations in the formation based on the logging data; perform an anisotropic inversion on the average resistivities to determine a horizontal resistivity, a vertical resistivity, and a dip angle of the formation; detect a location of a boundary of the formation based on the horizontal resistivity, vertical resistivity, and dip angle; perform a vertical inversion based on the location, horizontal resistivity, vertical resistivity, and dip angle; and output for display at least one of a result of the vertical inversion and a resistivity log based on the vertical inversion.

Detecting the location may cause the one or more processors to detect the location of the boundary of the formation only if an error of the anisotropic inversion is above a threshold. Performing the vertical inversion may cause the one or more processors to perform the vertical inversion based on the location, horizontal resistivity, vertical resistivity, and dip angle only if an error of the anisotropic inversion is above a threshold. Deriving average resistivities may cause the one or more processors to: derive an average resistivity for a transmitter and receiver pair; and derive an average resistivity for another transmitter and receiver pair. Performing the vertical inversion may cause the one or more processors to minimize a cost function until a parameter of the formation converges to a value. The parameter may be the location of the boundary. The cost function may include the difference between measurements from the logging data and a model of the formation. The one or more processors may be further caused to derive geosteering data based on the logging data. Detecting the location may cause the one or more processors to detect a location of a boundary of the earth formation based on the geosteering data. The logging tool may be a logging while drilling (LWD) tool.

While the present disclosure has been described with respect to a limited number of embodiments, those skilled in the art will appreciate numerous modifications and variations therefrom. It is intended that the appended claims cover all such modifications and variations.

What is claimed is:

1. A resistivity logging method, comprising:
obtaining resistivity logging data corresponding to a resistivity logging tool's position in a formation;
performing an anisotropic single-layer inversion on the resistivity logging data to determine a horizontal resistivity, a vertical resistivity, and a dip angle of the formation at the tool's position;
detecting a location of a boundary of the formation and performing a vertical multi-layer inversion based on the resistivity logging data in a window around said location, if a residual error for the anisotropic inversion exceeds a threshold; and
displaying a log of at least one inversion parameter from the anisotropic inversion or the vertical inversion based on said residual error.

2. The method of claim 1, further comprising conveying the tool along a borehole through the formation.

3. The method of claim 1, further comprising recording, on a non-transitory information storage medium, a log of the horizontal resistivity, vertical resistivity, or dip angle.

4. The method of claim 1, wherein obtaining resistivity logging data comprises obtaining resistivity logging data using multiple relative antenna orientations.

5. The method of claim 1, further comprising deriving a geosteering trajectory based at least in part on the at least one inversion parameter.

6. The method of claim 5, further comprising steering a drill string based on the derived geosteering trajectory.

7. The method of claim 1, wherein performing the vertical inversion comprises performing the vertical inversion based on the location, horizontal resistivity, vertical resistivity, and dip angle only if an error of the anisotropic inversion is above a threshold.

8. The method of claim 1, wherein performing the vertical inversion comprises minimizing a cost function until a parameter of the formation converges to a value.

9. The method of claim 8, wherein the parameter is the location of the boundary.

10. The method of claim 8, wherein the cost function comprises the difference between measurements from the logging data and a model of the formation.

11. A non-transitory computer-readable storage medium comprising instructions that, when executed, cause one or more processors to:
obtain resistivity logging data corresponding to only one position of a logging tool in a formation;
perform an anisotropic single-layer inversion on the resistivity logging data to determine a horizontal resistivity, a vertical resistivity, and a dip angle of the formation;
detect a location of a boundary of the formation based on the horizontal resistivity, vertical resistivity, and dip angle;
perform a vertical multi-layer inversion based on the location, horizontal resistivity, vertical resistivity, and dip angle; and
output for display at least one of a result of the vertical inversion and a resistivity log based on the vertical inversion.

12. The medium of claim 11, wherein detecting the location causes the one or more processors to detect the location of the boundary of the formation only if an error of the anisotropic inversion is above a threshold.

13. The medium of claim 11, wherein performing the vertical inversion causes the one or more processors to perform the vertical inversion based on the location, horizontal resistivity, vertical resistivity, and dip angle only if an error of the anisotropic inversion is above a threshold.

14. The medium of claim 11, wherein performing an anisotropic single-layer inversion causes the one or more processors to:
derive an average resistivity for a transmitter and receiver pair; and
derive an average resistivity for another transmitter and receiver pair.

15. The medium of claim 11, wherein performing the vertical inversion causes the one or more processors to minimize a cost function until a parameter of the formation converges to a value.

16. The medium of claim 15, wherein the parameter is the location of the boundary.

17. The medium of claim 15, wherein the cost function comprises the difference between measurements from the logging data and a model of the formation.

18. The medium of claim 11, wherein the one or more processors are further caused to derive geosteering data based on the logging data.

19. The medium of claim 18, wherein detecting the location causes the one or more processors to detect a location of a boundary of the earth formation based on the geosteering data.

20. The medium of claim 11, wherein the logging tool is a logging while drilling (LWD) tool.
